(19) United States
(12) Patent Application Publication
(10) Pub. No.: US 2012/0192749 A1
(43) Pub. Date: Aug. 2, 2012

(54) METHOD FOR MINIMIZING THE CARRY OFF OF ENTRAINED AIRBORNE MATERIAL AND APPARATUS FOR CARRYING OUT THE METHOD

(76) Inventor: Jeff McKinney, Asheville, NC (US)

(21) Appl. No.: 13/015,188

(22) Filed: Jan. 27, 2011

(51) Int. Cl. F42B 99/00; B01D 47/06; F42B 3/00

(52) U.S. Cl. 102/301; 261/115

(57) ABSTRACT

A method for minimizing the carry-off of entrained airborne material and an apparatus for carrying out the method are provided that are particularly suitable for deployment in an open pit mining operation in which cyclic blasting operations create debris that, by virtue of its very small (particle) size and weight, is susceptible to being carried beyond the open pit mining location and deposited in adjacent communities. The method and apparatus of the present invention beneficially minimize the “carry-off” risk of such debris without substantially interfering with the blasting and material handling and transport operations of an open pit mining operation.

### BACKGROUND OF THE INVENTION

One type of excavation project is open pit mining, wherein a number of explosive charges are individually placed into boreholes that have been dug into a ground floor of an open pit and the explosive charges are detonated to loosen and pulverize the top ground surface layers in the region of the boreholes. The loosened material is then typically transported to a nearby location, usually still within the confines of the open pit, to undergo further size reduction such as crushing and/or to be segregated into collections of similarly sized fragments or particles.

As a result of zoning variances and the effects of expansions of local communities, there are a number of open pit mining operations that occur in the vicinity of residences, public buildings such as schools, and commercial buildings. This means that these adjacent structures and their inhabitants are, at the least, subject to the blasting noise that accompanies an explosive charge detonation in an open pit and, beyond that, there are risks as well that entrained airborne material generated by a blasting operation drifts or is carried by prevailing winds from the open pit to these adjacent residential, municipal, and commercial structures. Entrained airborne material generated by a blasting operation can often include fine dust particles comprised of inert material as well as reactive material. Even inert material can cause unfortunate health consequences due to, for example, the penetration risk of very fine particles into the lungs of a person exposed to an airborne collection of such dust. The detrimental effects of dust dissemination and its safety, health, and environmental problems are well known in certain endeavors such as, for example, in the coal mining industry, wherein coal dust dissemination caused by wind or transit motion may lead to black lung disease and other respiratory ailments if inhaled over lengthy periods of time. In other cases, the presence of coal dust may lead to possible spontaneous combustion. Similar safety, health, and environmental problems also arise in operations such as open pit mining operations in which materials such as sulfur, phosphates, clays or other finely divided ores and minerals generate dust during excavation operations, including blasting operations, and during the handling transportation, and storage of the material that has been loosened by blasting operations. Even beyond safety, health, and environmental problems, entrained airborne material can cause economic problems. For example, dust can accumulate on a roof or wall surface of a structure such as a house or a building, resulting in discoloration or more rapid deterioration of the paint, siding, or roofing materials.

### SUMMARY OF THE INVENTION

One aspect of the present invention comprises a method of minimizing a carry off effected generated by exploding explosive material. The method comprises generating a liquid dispersion and initiating a detonation of explosive material. The explosive material creates entrained airborne material and the liquid dispersion is suspended relative to a travel path of the entrained airborne material such that the liquid dispersion interacts with the entrained airborne material and thereby minimizes the carry off of the entrained airborne material.

According to another feature of the method, the liquid comprises water and includes at least one soluble dust suppression composition. According to another aspect of the method, at least one soluble dust suppression composition from neutralizing agents and wetting agents. Another aspect of the method includes the explosive material positioned in a sunken area and a plurality of spray nozzles arranged to direct water in a spray into the interior of the sunken area to create the liquid dispersion. According to another feature of the method, the spray nozzles are in fixed positions and the sunken area comprises a pit. The method also may feature liquid supplied to the spray nozzles supplied from a pressurized liquid supply system.

Another aspect of the present invention includes an airborne debris control assembly comprising a dispersal arrangement configured to disperse a liquid material into the air where blast effects are to be suppressed, and a source of the liquid material.

### BRIEF DESCRIPTION OF THE DRAWINGS

FIG. 1 is an enlarged perspective view, in partial section, of a canister that can be launched by an airborne debris control assembly deployed at an open pit mining site;

FIG. 2 is a top perspective view of an open pit mining site and the airborne debris control assembly deployed at the open pit mining site;

FIG. 3 is a top perspective view of the open pit mining site with an initial travel path of a canister launched by the airborne debris control assembly;

FIG. 4 is a top perspective view of the open pit mining site which shows the position of the canister launched by the airborne debris control assembly at the end of the trajectory path of the canister;

FIG. 5 is a top perspective view of the open pit mining site showing a suppression formation of liquid particles;

FIG. 6 is a top perspective view of the open pit mining site showing schematically a first duration period immediately after an explosion of the grid of dynamite charges;

FIG. 7 is a top perspective view of the open pit mining site showing schematically a later duration period after an explosion of the grid of dynamite charges;

FIG. 8 is a perspective view of a material processing location at which blasting takes place;

FIG. 9 is a schematic view of a pump assembly;

FIG. 10 is a perspective view of a rock size reduction machine;

FIG. 11 is an enlarged perspective view of the pendant platform; and

FIG. 12A is a top perspective view of the open pit mining site and

FIG. 12B is a top plan view of the open pit mining site with a variation of the airborne debris control assembly.

### DETAILED DESCRIPTION OF AN EMBODIMENT

The present invention provides a method for minimizing the carry-off of entrained airborne material and an apparatus for carrying out the method. The following description will reveal in more detail the advantageous features of the method and apparatus of the present invention and, in particular, will show the particular suitability of the method and apparatus of the present invention for deployment in an open pit mining operation in which cyclic blasting operations create debris which, by virtue of its very small (particle) size and weight, is susceptible to being carried beyond the open pit mining location and deposited in adjacent communities. The method and apparatus of the present invention beneficially minimize the “carry-off” risk of such debris without substantially interfering with the blasting and material handling and transport operations of an open pit mining operation.

As an example of the customized approach that the apparatus of the present invention provides for minimizing the carry-off of entrained airborne material, reference is first had to FIG. 1, which is an enlarged perspective view, in partial section, of a canister that can be launched by an airborne debris control assembly deployed at an open pit mining site. The canister 610 is a custom configured vessel that is specifically configured to disperse liquid particles—which can be droplets, larger sized drops, or a continuous stream—at a selected suppression location, whereupon these dispersed particles interact with specific airborne materials that are thrown skyward by an explosion. The canister 610 includes a central passage 612, a sprinkler head 614 located at the top of the central passage 612, a plurality of water chambers 616 each for storing a load of water, and a plurality of auxiliary chambers 618 each for storing a load of a soluble dust suppression composition. The water chambers 616 and the auxiliary chambers 618 are all communicated with the central passage 612 such that water and the soluble dust suppression composition can flow to the sprinkler head 614 for dispersal by the sprinkler head. As will become clear in the following description, the canister 610 is one example of the customized features of the apparatus of the present invention that advantageously minimizes the carry-off of entrained airborne material.

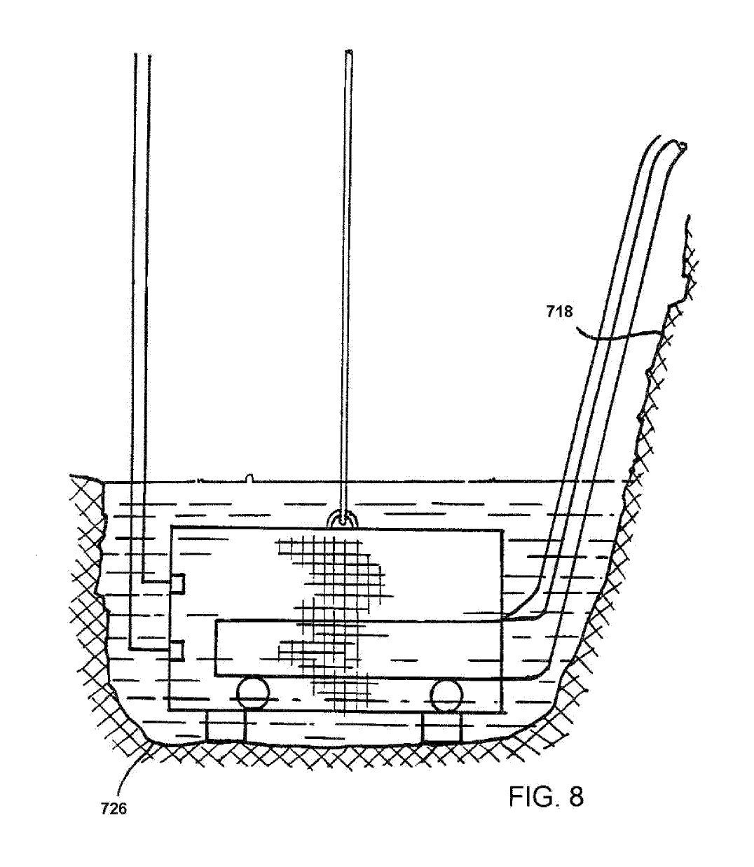

Reference is now had to FIG. 8, which is a perspective view of a material processing location at which blasting takes place that could be beneficiated by the method of the present invention. FIG. 8 shows a rock quarry 710 that is being excavated to yield rock fragments for a rock size reduction operation in which the larger rock fragments are reduced in size to a smaller, relatively more uniform size such as, for example, gravel stone size. The rock quarry 710 has an upper portion 712 with a floor 714, the upper portion 712 having been quarried down to adjacent the natural water table of the quarry 710. The removal of further rock from the quarry 710 requires dislodgement and removal of rock located below the natural water table of the quarry—namely, removal of rock from a hole 716 in the floor 714 of the quarry 710.

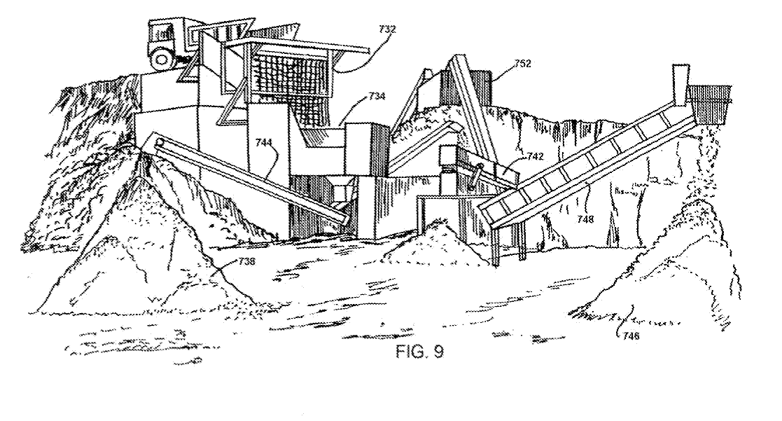

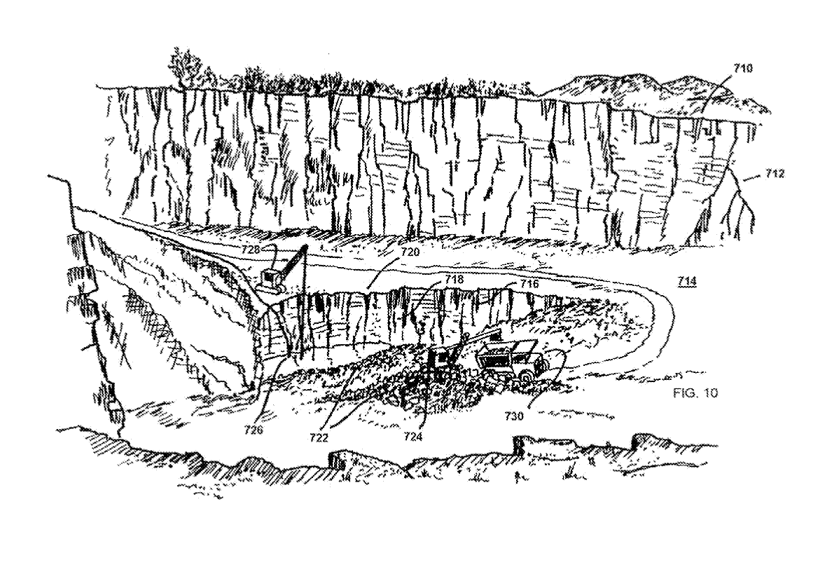

The rock extraction process includes drilling a number of bore holes individually spaced-apart from one another along a top edge 720 of a rock face 718. Each bore hole is charged with a blasting compound and the rock face 718 is blasted, whereupon blasted rock 722 falls into the hole 716. A powered shovel 724 then enters the hole 716 and excavates a sump 726 at a base of the rock face 718. As shown in FIG. 9, which is a schematic view of a pump assembly, a submersible pump assembly is lowered by any suitable means, such as a crane 728 for example, into the sump 726. The pump is operated to lower the water level within the hole 716 to enable removal of the blasted rock 722. Once the water level within the hole 716 has been reduced a loader 724 enters the hole 716 and loads the blasted rock 722 into a dump truck 730. As seen in FIG. 10, which is a perspective view of a rock size reduction machine, the dump truck transports the rock to a hopper 732 at an inlet of an impact crusher 734. Chains suspended at an outlet of the hopper 732 control the feed of rock into the impact crusher 734. Within the impact crusher 734, rock is reduced to a nominal size of less than 75 mm. Scalpings are discharged from the impact crusher 734 on a laterally extending conveyor 736 to a scalping stockpile 738. Crushed rock discharged from the impact crusher 734 is delivered by means of a conveyor 740 to a primary vibrating screen 742. The primary vibrating screen 742 separates the rock material, delivering material sized—10 mm via conveyor 744 to a stockpile 746. Larger material, typically sizes between 10-75 mm is discharged from the vibrating screen onto a screen discharge conveyor 748 having an outlet end 750 positioned over a feed hopper 752 for a granulator 754.

Reference is now had to FIGS. 2-7 for a description of the method of the present invention for minimizing the carry-off of entrained airborne material and this description also sets forth the details of one suitable configuration of the apparatus of the present invention for carrying out the method, this suitable configuration of the apparatus of the present invention being generally designated as an airborne debris control assembly 204 that is operated to ameliorate the effects of the blasting operations. FIG. 2 is a top perspective of an open pit mining site and the airborne debris control assembly deployed at the open pit mining site. As seen in FIG. 2, the open pit mining site 206 is a site at which blasting operations are cyclically performed to loosen and pulverize material and, additionally, many of the material handling and transport activities described with respect to the material processing location shown in FIGS. 8-10 can be performed as well at this open pit mining site 206. In accordance with the method of the present invention, the airborne debris control assembly 204 is operated to ameliorate the effects of the blasting operations at the open pit mining site 206 and the airborne debris control assembly includes a computer control console 208 and a customized mobile trailer 210 operatively coupled to the computer control console 208 and comprising a canister launcher 212. The trailer 210 is positioned relative to the open pit mining site 206, as will be described in more detail, for performing a dust control operation in accordance with the method of the present invention. The open pit mining site 206 includes a horizontal plane of rock 214 that has been selected for surface mining and the horizontal plane of rock 214 is bordered by exposed vertical rock walls 218. The open pit mining site 206 is adjacent to a local community having residential, municipal, and commercial structures.

A top layer or free face of the rock plane 214 of the mining site 206 is to be separated from the ground structure below via a known blasting method involving the simultaneous detonation of a plurality of explosive charges distributed on the rock plane 214. As a result of the simultaneous detonation of the explosive charges, “flyrock” in the form of rock particles thrown into the air by the rapid release of energy (e.g., blast) will be generated and these rock particles will subsequently be collected and transported to a rock crusher or other size reduction equipment for processing. Flyrock may be in the form of a shower of small pieces at relatively high velocities (20 to 50 m/s typical). Flyrock may also be in the form of larger pieces of rock at relatively low velocity (1 to 10 m/s typical), which typically originate in the mass of rock excavated from a crater formed by the blasting event. Additionally, other materials such as silica particles of a very fine particle size may be released by the blasting event.

A grid of dynamite charges 216 are distributed on the rock plane 214 with each dynamite charge being situated in an individual borehole. A plurality of wires connects each of the dynamite charges 216 to a common lead wire that is connected to a demolition triggering device 220. The demolition triggering device 220 is also operatively connected to the computer console 208 at a perimeter surrounding the horizontal plane of rock 214 which, in turn is ported to the trailer 210 for launching instructions in coordination with dynamite blast timing. In preparation for a blasting operation, an operator (not shown) performs the usual steps associated with verifying the operative connections between the demolition triggering device 220 and the computer console 208 and scheduling a countdown of the demolition triggering device 220 to initiate a detonation of the explosive charges 216. The operator also inputs program instructions to the computer console 208 to control the operation of the canister launcher 212 such as, for example, instructions that may control a mechanical linkage (not shown) that aims the canister launcher 212 in a proper firing direction. Subsequent instructions may prompt a verification routine that confirms that the canister launcher 212 is ready to fire a liquid dispersion canister 310 in a predetermined trajectory.

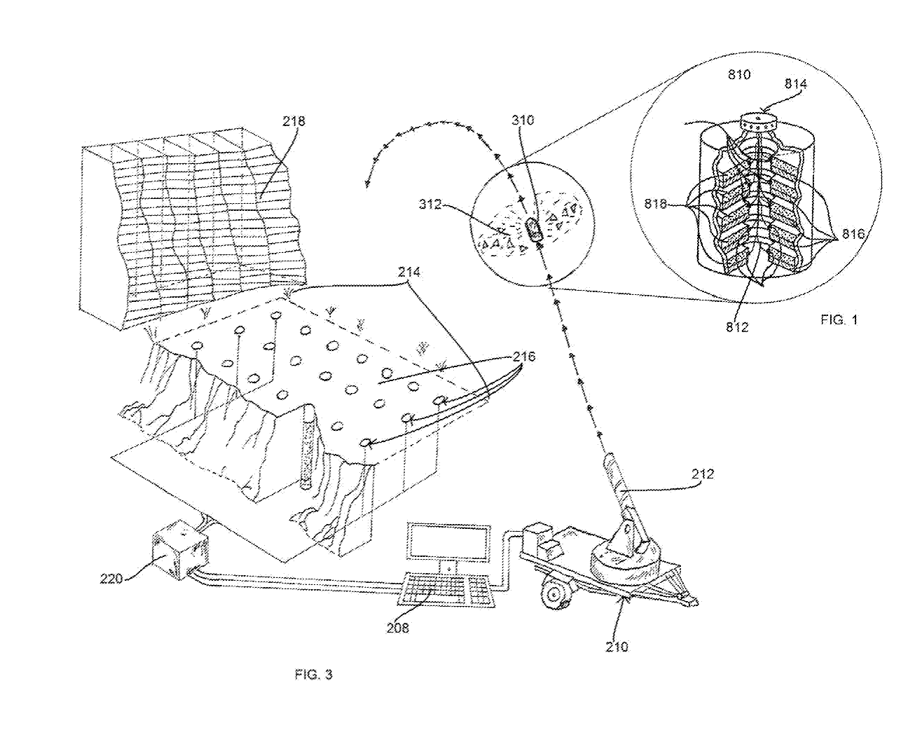

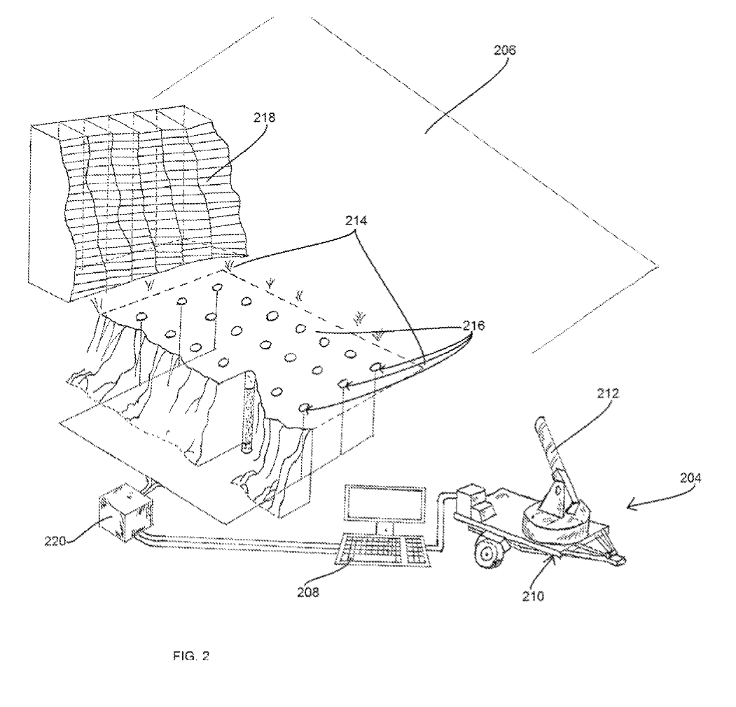

With reference now to FIG. 3, which is a top perspective of the open pit mining site shown in FIG. 2 and showing an initial travel path of a canister launched by the airborne debris control assembly, the computer control console 208 has coordinated the detonation of the grid of dynamite charges 216 in accordance with a programmed countdown with the operation of the canister launcher 212 to as to achieve a desired effect in which the liquid dispersion canister 310 brings about suppression of the entrained material that becomes airborne due to the blast detonation. As seen in FIG. 3, the computer console 208 has coordinated the detonation of the grid of dynamite charges 216 to delay the ignition of these dynamite charges until the liquid dispersion canister 310 has first taken flight into the atmosphere and has traveled along an initial travel path equal to approximately halfway of its full trajectory. This coordinated timing permits a release of an initial spread of liquid particles 312 in a general radius over the horizontal plane of rock 214 to be performed prior to the detonation of the explosive charges 216. During this release of an initial spread of liquid particles 312 in a general radius over the horizontal plane of rock 214, the computer console 208 has not yet caused the demolition triggering device 210 to activate the explosion of the dynamite charges 216; this delay is carried out for the specific purpose of ensuring that the overhead expanding radius of the liquid particles 312 (indicated by triangles in FIG. 3) results in the liquid particles 312 being in position with respect to a subsequently rising cloud of entrained airborne material to have a desired absorption or suppression effect on this entrained airborne material.

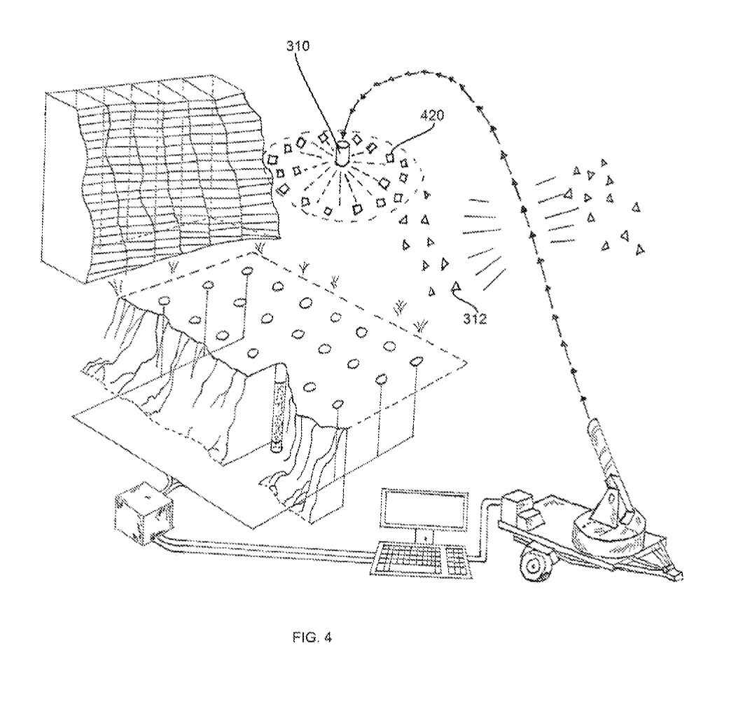

With reference now to FIG. 4, which is a top perspective of the open pit mining site shown in FIG. 2 and showing the position of the canister launched by the airborne debris control assembly at the end of the trajectory path of the canister, it can be seen that the liquid dispersion canister 310 has now reached traveled past the apex of its trajectory and has begun to descend, the canister 310 having reached as a location at which it begins to disperse a final spread of liquid particles 420 (indicated by squares) in a radius further directly over the horizontal plane of rock 214. The final spread of liquid particles 420 now spreads radially outwardly as the initial spread of the liquid particles 312 substantially finishes its radially outward expansion and these liquid particles 312 begin falling to the ground by the nature of gravity. The dispersal regime shown in FIGS. 3 and 4 illustrates one approach to achieve an adequate amount of dispersion of liquid particles with the intent of blanketing the horizontal plane of rock 214 and the air space directly above it with liquid particles 312 and 420.

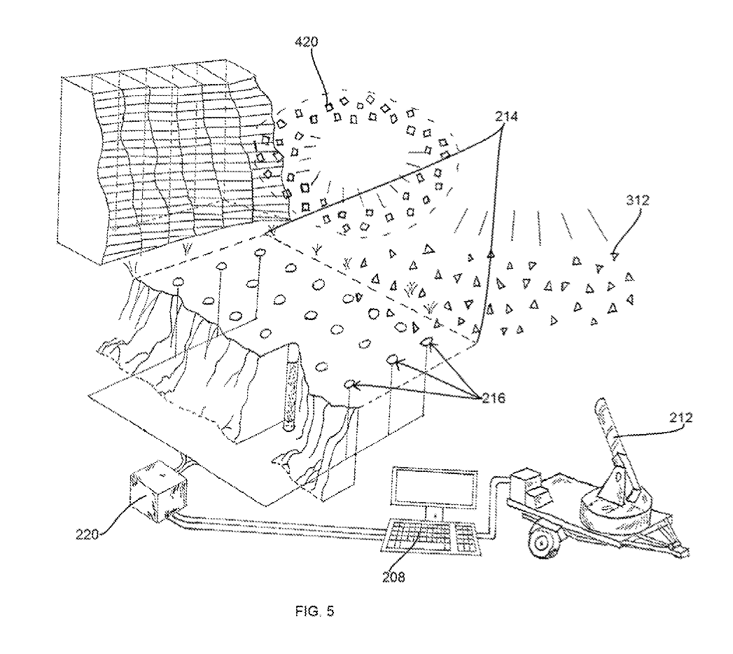

With reference now to FIG. 5, which is a top perspective of the open pit mining site shown in FIG. 2 and showing a suppression formation of liquid particles, it can be seen that the final spread of liquid particles 420 have achieved an expanded radius in comparison to the spread of these liquid particles shown in FIG. 4 and the liquid particles 302 have continued their descent under the influence of gravity. The liquid particles 420 have now spread horizontally outwardly and have started to descend (due to gravity) along a vertical axis. Simultaneously with the dispersion of the liquid particles 420 is the activity of the liquid particles 312 which have spread and fallen closer to the horizontal plane of rock 214. At this point in time, the liquid dispersion canister 310 has completed its trajectory from the canister launcher 212 and is now considered spent, having released all of its liquid particles that have formed a the suppression formation of liquid particles that is in place over the horizontal plane of rock 214. The grid of dynamite charges 216 has not yet been activated as the command from the computer console 208 has not been sent to the demolition triggering device 220.

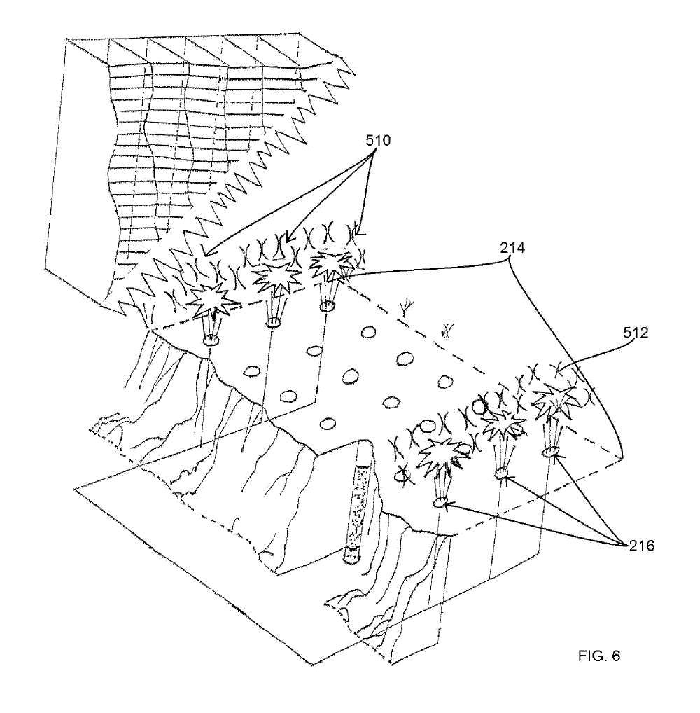

With reference now to FIG. 6, which is a top perspective of the open pit mining site shown in FIG. 2 and schematically a first duration period immediately after an explosion of the grid of dynamite charges, the ignition of the dynamite charges 216 has now been initiated by the computer control console 208 after the creation of the suppression formation of liquid particles consisting of the liquid particles 312 and 420 and this suppression formation of liquid particles is in position directly overhead the detonated charges 216 (the suppression formation of liquid particles is not shown in FIG. 6 for the sake of clarity). The ignition of the dynamite charges 216 causes a release of an airborne mixture 510 of entrained airborne material that rises above the horizontal plane of rock 214 due to the force of the explosion. The airborne mixture 510 comprises rock dust particles 512 (indicated by oppositely paired curved segments) and entrained airborne material.

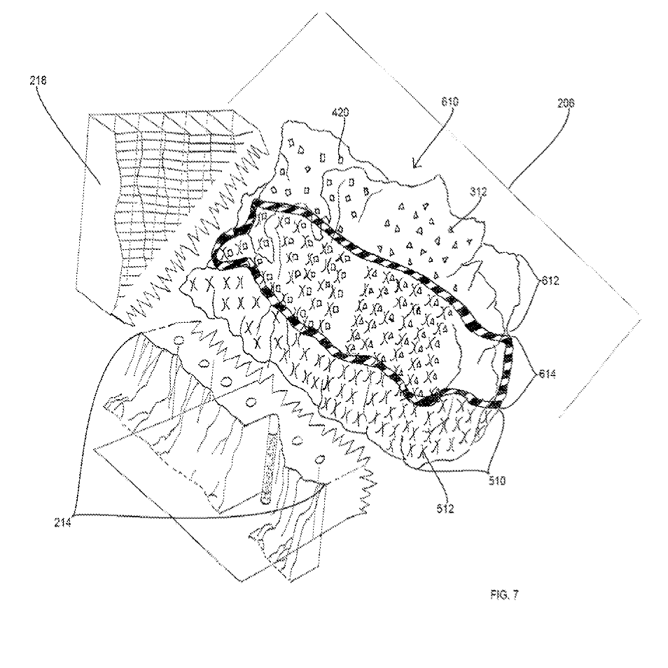

With reference now to FIG. 7, which is a top perspective of the open pit mining site shown in FIG. 2 and schematically a later duration period after an explosion of the grid of dynamite charges, an inter-mixed cloud 610 is shown which is adjacent to exposed vertical rock walls 218 and lies above a horizontal plane of rock 214. The inter-mixed cloud 610 is comprised of the liquid particles 312 and 420 and the airborne mixture 510 comprising rock dust particles 512 and entrained airborne material. Furthermore, within the inter-mixed cloud 610 is a stratification comprising layers, the lowermost layer of which is the airborne mixture 510; the middlemost layer of which is an emulsion mixture 614; and the uppermost layer of which is a remainder liquid particles layer 612. The emulsion mixture 614 comprises of the liquid particles 312 and 420 which have wetted the dust rock particles 512 and entrained airborne material rendering these particles heavier. The now heavier dust rock particles 512 and entrained airborne material fall under the influence of gravity towards the earth. To the extent that these dust rock particles 512 and entrained airborne material have been sufficiently wetted, these dust rock particles 512 and entrained airborne material will fall towards the earth before any prevailing winds can carry them beyond the perimeter of the open pit mining site 206, thereby containing the dust rock particles 512 and entrained airborne material within the open pit boundaries.

When the detonation of the explosive charges 316 occurs, a shock wave is generated and this shock wave loses energy as it contacts the inter-mix cloud 610. This causes the shock wave to slow and weaken due to a lower overpressure rise and less shock heating of the air. Further, as the shocked air interacts with the droplets, it is cooled, reducing its pressure. In addition, the outward velocity of the shocked air is reduced, thereby lowering the dynamic pressure. When the particles of the entrained airborne material mixes with the “wetted” air that has been wetted by water and the dust suppression composition released from the canister 310, the temperatures of the particles of the entrained airborne material are reduced, and their reactivity with oxygen in the air is lessened. Overall, the radiant heat and the reactive effect associated with the blasting are lessened in addition to reducing the effective intensity of the blasting.

Water is desirable an “air wetting agent” because of its high heat of vaporization and high specific heat capacity. The presence of the water droplet suspension causes the shock wave to weaken rapidly as it travels, and also cools the shock heated air. Furthermore, water is inert, can often be obtained at a relatively low cost, is easy to deliver, and has a high specific heat capacity. With respect to the dust suppression composition, the freezing point or viscosity of the dust suppression composition may be changed due to utilization of appropriate additives such as certain salts, ethylene glycol or propylene glycol. Furthermore, additives to cause the dust suppression composition to partially foam could be used.

The properties and characteristics of the dispersed water and/or dust suppression composition droplets or drops can be selected to optimize the control of the airborne particles. For example, the properties and characteristics of the dispersed water and/or dust suppression composition can be selected to provide beneficial interaction with silica particles or other very finely sized particles. As a specific example, it may be beneficial to atomize the dispersed water and/or dust suppression composition to increase the surface area of the dispersed particles. For a given mass of fluid, the total surface area is proportional to the cube root of the number of droplets. The droplet sizes may be in ranges preferably from about 1 mm to 0.01 mm, more preferably from about 0.5 mm to 0.01 mm and most preferably from about 0.1 mm to 0.01 mm.

It can thus be readily understood that the trailer configuration of the airborne debris control assembly permits the airborne debris control assembly to be conveniently and easily deployed in an open pit area. Also, the flow rate, flow pattern, and droplet size of the water and the dust suppression composition can be adjusted to maximize the “wetting” of the area above the blasting charges 316. For example, the airborne debris control assembly could be sensor-adjusted, such that wind drift sensors could adjust the direction or adjust the droplet size of the dispersed water and dust suppression composition to maintain proper coverage of the selected area.

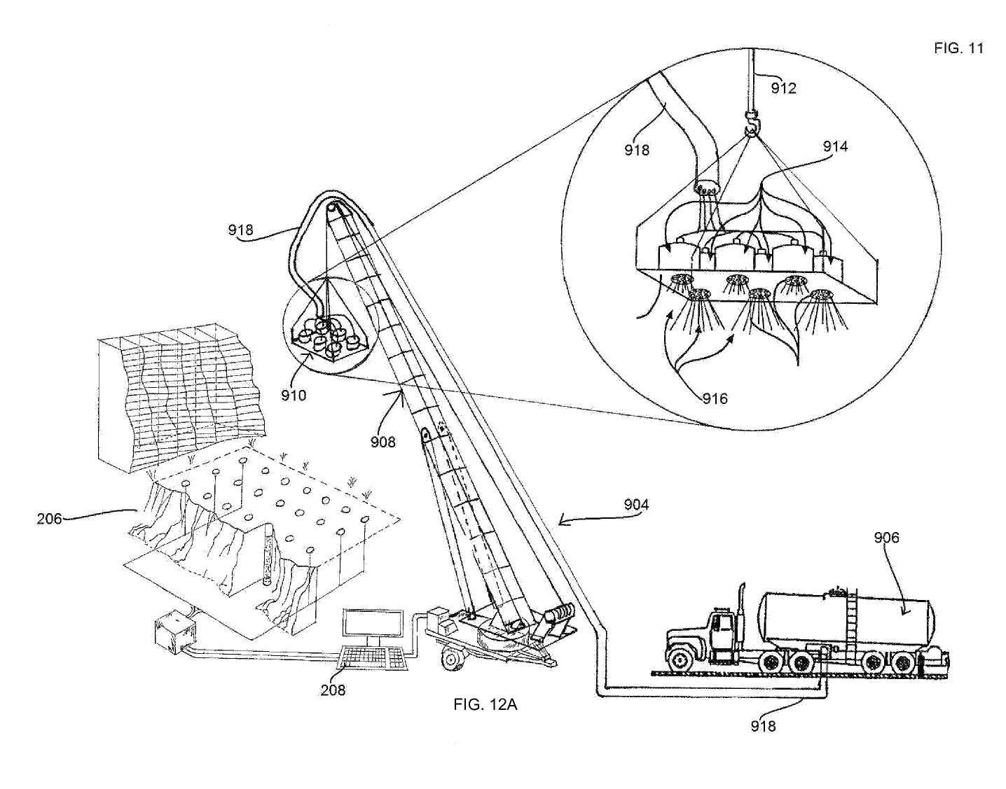

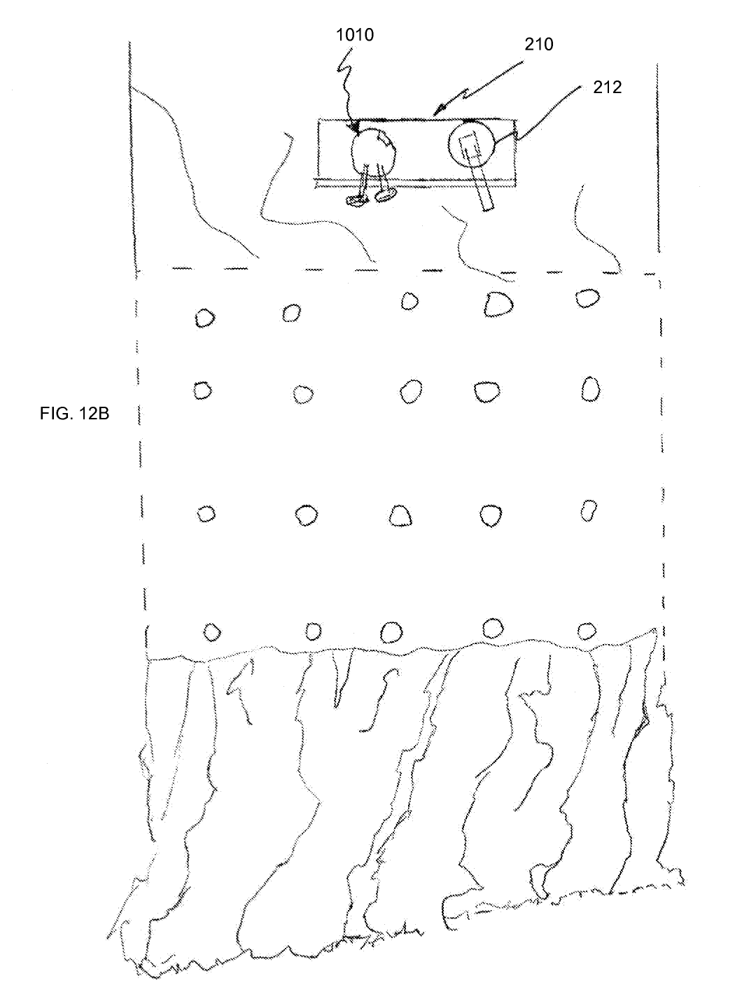

Reference is now had to FIGS. 11 and 12 for a description of another suitable configuration of the apparatus of the present invention for carrying out the method, this configuration of the apparatus of the present invention being generally designated as an airborne debris control assembly 904 that is operated to ameliorate the effects of the blasting operations. FIG. 12A is a top perspective of the open pit mining site 206 and the airborne debris control assembly 904 deployed at the open pit mining site. The airborne debris control assembly 904 is operated to ameliorate the effects of the blasting operations at the open pit mining site 206 and includes a dispersion liquid supply truck 906, a boom arm rig 908 and a pendant platform 910 supported by guy wires 912 from the boom arm rig 908. The boom arm rig 908 can be mounted, for example, on the same chassis as the trailer 210, and the boom arm rig is operable to support the pendant platform 910 at a selected height above a blasting site. As seen in FIG. 11, which is an enlarged perspective view of the pendant platform 910, the pendant platform has a plurality of dosing cylinders 914 each having an associated sprinkler head 916 and the dosing cylinders 914 are all communicated via a mains supply hose 918 with the dispersion liquid supply truck 906. The computer control console 208 controls the dispensing of a water and soluble dust suppression composition from the sprinkler heads 916 to effectively minimize a carry off of the entrained airborne materials generated by a blasting operation. FIG. 12B is a top plan view of the open pit mining site with an variation of the airborne debris control assembly in which the customized mobile trailer 210 comprises the canister launcher 212 and a combination water storage tank/multiple nozzle dispenser 1010. The combination water storage tank/multiple nozzle dispenser 1010 is operable to retain several hundred gallons of a liquid such as water or a water mixture and includes a rapid pump mechanism that evacuates the stored water rapidly through a plurality of nozzles that can be oriented toward a blast site. The trailer 210 is positioned relatively closely to a blast location of a open pit mining site and both the canister launcher 212 and the combination water storage tank/multiple nozzle dispenser 1010 can be operated in coordination with one another for performing a dust control operation in accordance with the method of the present invention.

The teachings of this application are not to be construed as being limited to any particular system or method. While various embodiments of the invention have been described and illustrated herein, it is to be distinctly understood that the invention is not limited thereto, but may be otherwise variously embodied and practiced within the scope of the following claims.

It is claimed:

1. A method of minimizing a carry off effected generated by exploding explosive material, the method comprising:
generating a liquid dispersion;
initiating a detonation of explosive material, the explosive material creating entrained airborne material and the liquid dispersion being suspended relative to a travel path of the entrained airborne material such that the liquid dispersion interacts with the entrained airborne material and thereby minimizes the carry off of the entrained airborne material.

2. A method according to claim 1, wherein the liquid comprises water.

3. A method according to claim 1, in which the liquid includes at least one soluble dust suppression composition.

4. A method according to claim 3, in which the at least one soluble dust suppression composition comprises neutralizing agents and wetting agents.

5. A method according to claim 1, wherein the explosive material is positioned in a sunken area and a plurality of spray nozzles are arranged to direct water in a spray into the interior of the sunken area to create the liquid dispersion.

6. A method according to claim 5, in which the spray nozzles are in fixed positions.

7. A method according to claim 5, in which the sunken area comprises a pit.

8. A method according to claim 7, wherein the spray nozzles disperse liquid from a vessel traveling along an airborne trajectory.

9. A method according to claim 1, wherein the liquid supplied to the spray nozzles is supplied from a pressurized liquid supply system.

10. An airborne debris control assembly comprising:
a dispersal arrangement configured to disperse a liquid material into the air where blast effects are to be suppressed, and
a source of the liquid material.

11. The system according to claim 10, wherein the liquid material contains water.

12. The system according to claim 10, wherein the dispersal arrangement is stationary.

13. The system according to claim 10, wherein the dispersal arrangement is mobile.

14. The system according to claim 10, wherein the liquid material when dispersed forms a plurality of droplets.

15. The system according to claim 10, wherein the liquid material when dispersed is dispersed in the form of a spray.

16. The system according to claim 10, wherein the dispersal arrangement has a flow rate and flow pattern, both of which can be adjusted.
